(19) United States
(12) Patent Application Publication
(10) Pub. No.: US 2005/0018631 A1
(43) Pub. Date: Jan. 27, 2005

(54) Frequency hopping spread spectrum communication system

(76) Inventors: T V L N Sivakumar, Tokyo (JP); Timo Olavi Eriksson, Tokyo (JP)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/500,487

(22) PCT Filed: Dec. 27, 2002
(86) PCT No.: PCT/IB02/05798

(30) Foreign Application Priority Data
Dec. 31, 2001 (GB) 0131117.4

(51) Int. Cl. H04Q 7/00

(52) U.S. Cl. 370/329

(57) ABSTRACT

A method of operating a frequency hopping spread spectrum, preferably a Bluetooth piconet, comprising a central node and dependent nodes which communicate over a time division duplexed, frequency hopping channel, alternate time-wise frequency/time slots being allocated for central node and dependent node transmission, wherein a first of said dependent nodes is not permitted to transmit in a frequency/time slot which immediately succeeds, time-wise, a frequency/time slot in which the central node transmitted to another of said dependent nodes, comprising the steps of: the central node maintaining a black-list of worse-performing frequency bands in the channel, and transmitting a dummy packet in a frequency/time slot immediately preceding, time-wise, a frequency/time slot allocated for possible dependent node transmission at a frequency band which is black-listed.

The present invention relates to a frequency hopping spread spectrum communication system.

In most countries, the part of the spectrum commonly known as the Industry Scientific Medicine or ISM band (in the region of 2.4 GHz) is largely unregulated, meaning that no licence is needed to make electromagnetic transmissions in this band.

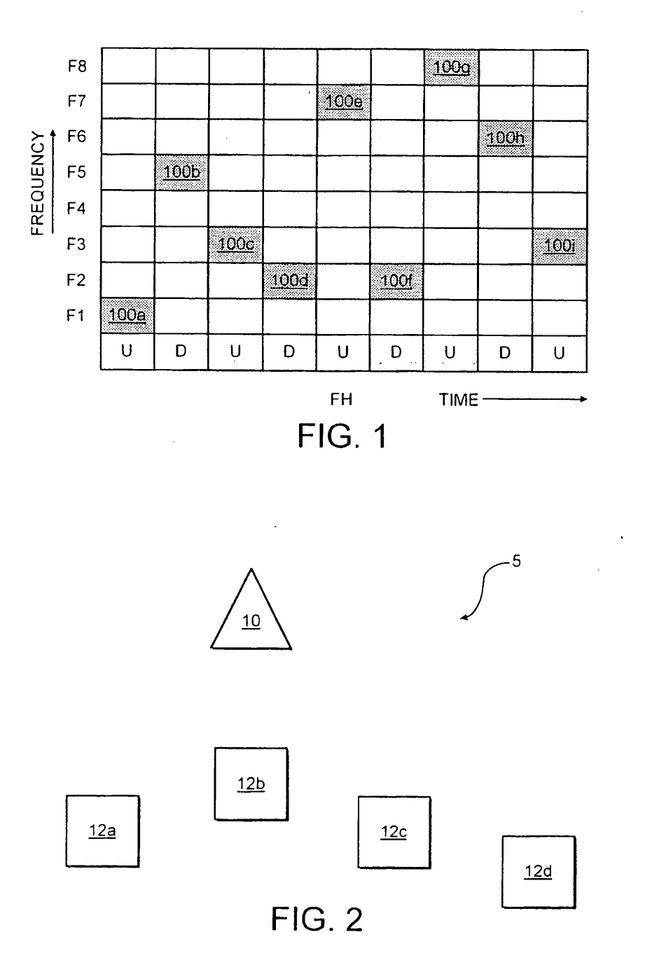

In this unruly part of the spectrum, frequency hopping spread spectrum systems have been found to have good performance. In these systems, the carrier frequency of a modulated information signal changes or hops periodically to another (or possibly the same) frequency of a set of possible frequencies called the hopset. The hopping sequence is governed by the spreading code. FIG. 1 shows the time/frequency occupancy of an exemplary communication between two nodes of a frequency hopping spread spectrum system. Thus, because the frequency hopping spread spectrum system is continually hopping between parts of the spectrum, the effect of narrow band interference in a particular region is limited.

The present invention is concerned with the operation of a frequency hopping spread spectrum communication system in the presence of a “persistent interferer” such as, for example, a microwave oven or a WLAN network operating at a fixed region of the spectrum.

Persistent interferers present two distinct problems to this kind of system.

(i) “System Performance”

Although the use of a frequency hopping spread spectrum system per se limits the degradation in system performance caused by a persistent interferer, the effect on system performance can be significant, especially in the presence of several persistent interferers.

(ii) “System Compatibility”

WLANs often transmit data in large packets. The presence of a nearby frequency hopping spread spectrum regularly hopping into the region of the spectrum used by the WLAN during the transmission of a large packet can have a devastating effect on the WLAN's performance.

With this background in mind, according to the invention, there may be provided a method of operating a frequency hopping spread spectrum comprising a central node and dependent nodes which communicate over a time division duplexed, frequency hopping channel, alternate time-wise frequency/time slots being allocated for central node and dependent node transmission, wherein a first of said dependent nodes is not permitted to transmit in a frequency/time slot which immediately succeeds, time-wise, a frequency/time slot in which the central node transmitted to another of said dependent nodes, comprising the steps of:
the central node maintaining a black-list of worse-performing frequency bands in the channel, and transmitting a dummy packet in a frequency/time slot immediately preceding, time-wise, a frequency/time-slot allocated for possible dependent node transmission at a frequency band which is black-listed.

By virtue of these features, the central node is able to preventatively forestall the use of the worse-performing frequency bands without any additional dedicated signaling protocols. By preventing the use of the worse-performing frequency bands, the method of the present invention represents a much less disruptive influence on neighbouring ISM-band systems.

Exemplary embodiments of the invention are hereinafter described with reference to the accompanying drawings, in which:

FIG. 1 shows the time/frequency occupancy of a frequency hopping spread spectrum communication system:

FIG. 2 shows a frequency hopping spread spectrum communication system having 5 nodes;

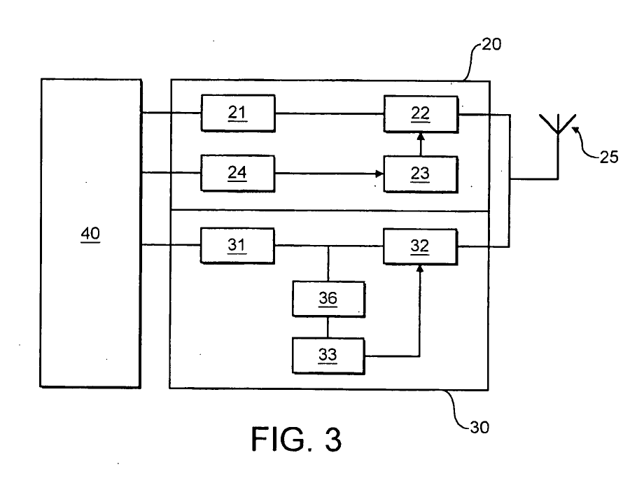

FIG. 3 shows a hardware block diagram for a node of FIG. 2;

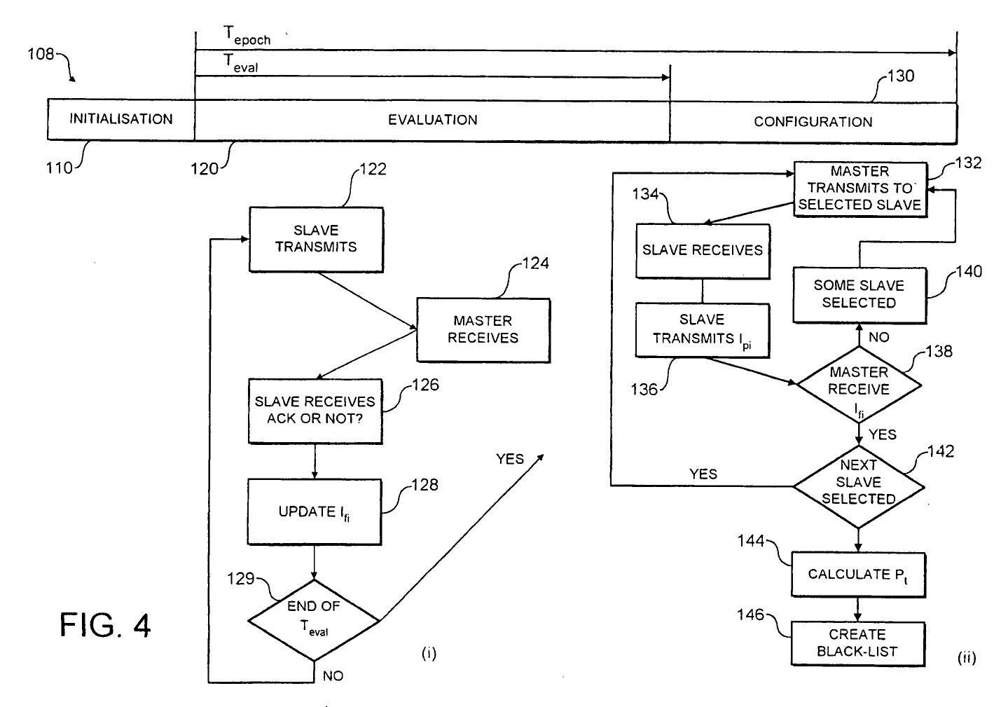

FIG. 4 show a diagram illustrating the operation of the system;

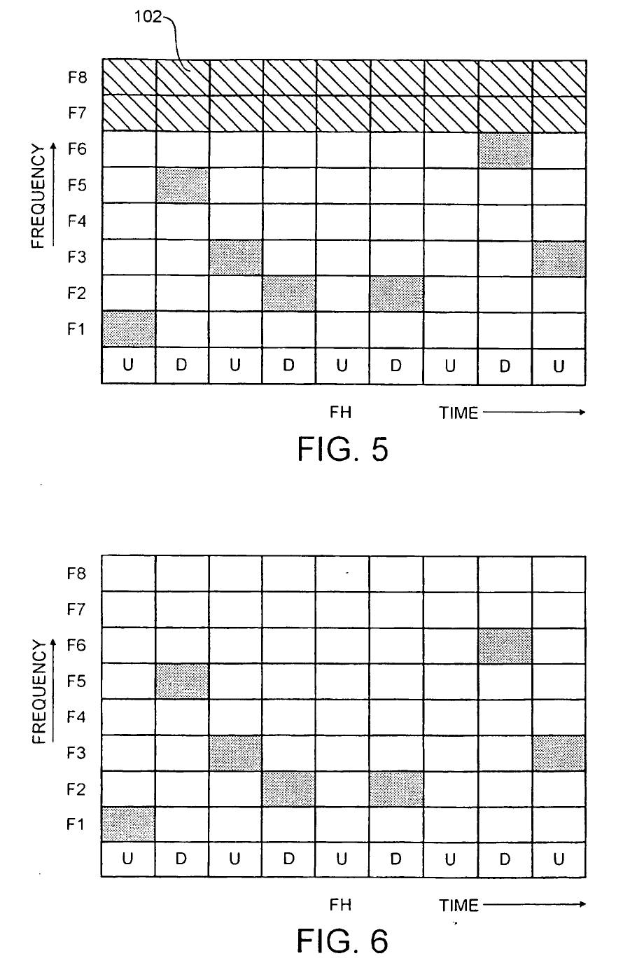

FIG. 5 shows the time/frequency occupancy of the channel of the FIG. 2 system in the presence of a persistent interferer; and

FIG. 6 shows time/frequency occupancy of the channel of FIG. 2 system where 2 black-listed frequency band are removed from the hop set.

FIG. 2 shows a frequency hopping spread spectrum system, generally designated 5, operating in the ISM band. The system 5 comprises five nodes arranged as a piconet, in which a node 10 serves as the master node and the other four nodes serve as slave nodes 12a, 12b, 12c and 12d. These devices are lower power RF devices, preferably operating in accordance with the Bluetooth protocol. Within the system 5, communication takes place, bidirectionally, between the master node 10 and any of the slave nodes 12a, 12b, 12c and 12d. No communication takes place directly between the slave nodes themselves.

Each node 10,12 is identical having the same hardware and the same software enabling it to be operable to act as a master node or a slave for a given network, or possibly acting as the master node for a first network while simultaneously acting as a slave node for a second network.

In more detail, referring to FIG. 3, each node 10,12 comprises a transmitter 20, a receiver 30 and a control processor 40. The transmitter 20 comprises a baseband modulator 21 to which baseband data for transmission is supplied by the control processor 40. The baseband modulator produces a modulated data signal and feeds it to an upconverter 22. The upconverter 22 shifts the modulated data signal to a frequency dictated by a frequency synthesiser 23 for transmission by an antenna 25. The output frequency of the frequency synthesiser 23 is controlled by a spreading code output by a code generator 24. The receiver 30 comprises a complementary architecture. A downconverter 32 shifts the signal received via an antenna 35 to a lower frequency, governed by the output frequency of a frequency synthesiser 33, and feed this frequency-shifted signal to a demodulator 31 for demodulation to baseband data. The output frequency of the frequency snythesiser is controlled by a locally generated spreading code output from a code generator 34. Synchronization and tracking circuitry 36 ensure that the locally generated carrier synchronises. sufficiently well to the received carrier so that correct despreading of the received signal is possible.

FIG. 4 show a diagram illustrating the operation of the system. A time line 108 shows the system in various phases of operation: initialisation 110, evaluation. 120, and configuration 130. The time in which the evaluation phase takes place is referred to as the evaluation interval, Tₑᵥₐₗ, and the time in which the evaluation phase and the configuration phase take place is referred to as an epoch, T_{epoch}.

On initialisation, each slave node 12, as it joins the piconet, is given a local piconet address, by which the master node addresses the slave node, and is synchronised to follow a hop sequence F within the frequency range comprising frequency bands F1 to F8, the portion of the hop sequence shown in FIG. 1 being F1, F5, F3, F2, F7, F2, F8, F6, F3 and the corresponding time/frequency slot being labeled 100a-i. Each time slot in the hop sequence is alternately reserved for transmission by the central node 10 (D slots) and transmission by the dependent nodes (U slots). In Bluetooth, the maximum number of slaves in a single piconet is 7. System parameters, for example, Tₑᵥₐₗ and T_{epoch} are also set in this initialisation phase.

After initialisation, for the evaluation interval, Tₑᵥₐₗ, communication between each slave node 12 and the master node 10 takes place as illustrated by flowchart (i) of FIG. 4,

If a slave node, say node 12a, wants to transmit a packet to the master node 10, it waits until the next available U time/frequency slot, for example, time/frequency slot 100a (shown in FIG. 1), and makes its transmission during this time/frequency slot 100a, step 122, and waits for an acknowledgement from the master node 10, step 124, on the next D slot, namely time/frequency slot 100b (shown in FIG. 1).

If an acknowledgement (ACK) is not received in time/frequency slot 100b, then the slave node 12a assumes that the packet transmitted in time/frequency slot 100a was not properly received by the master node 12 (step 126). The failure of the master node to receive the incoming packet could have been because of collision with an attempted packet transmission by another slave node 12b-d in the same system, collision with a neighbouring similar system having a different master node, or interference from the previously-mentioned persistent interferers such a microwave or a WLAN network.

The slave node 12a maintains a record for the evaluation interval, Tₑᵥₐₗ, of how many times it has tried to make a transmission on each frequency band F1-8, Tᵢ, and how many of those times the transmission was successful, NSᵢ and, from this information, calculates, at step 128, a local interference indices I_{Fi} (where in this exemplary system i=1 to 8 because there are eight frequency bands in the channel). In this case, the slave node 12a calculates a new value for I_{F1} because the packet transmission was attempted on U time slot 100a, which occupies frequency band F1, according to the relationship
I_{F1}=(T₁−NS₁)/T₁ (1)

This process is repeated every time the slave node 12a fails to successfully transmit a packet or to transmit a packet for the first time. Each slave node 12 independently carries out the same process.

In this way, each slave node 12 builds up a picture over the evaluation interval, Tₑᵥₐₗ, of its own local view of how prone to interference each frequency band, F1 to F8, in the channel is. This picture is encapsulated in the interference indices I_{Fi} stored at each slave node 12.

At the end of the interval, the system moves into the configuration phase 130 as illustrated by flowchart (ii) in FIG. 4. The master node 10 broadcasts on a b time/frequency slot a command addressed to a selected node to transmit its local interference indices I_{Fi} to the master node on the next U slot (step 132). At step 134, the addressed slave 12 receives the request and, at step 136, transmits the interference indices I_{Fi}. At steps 138,140 and 132, if the master node 10 does not properly receive the interference indices I_{Fi}, it re-makes its request on the next D time/frequency slot. The master node 10 repeats this interrogation process until it has successfully received the local interference indices for each dependent node (step 142).

With the interference indices I_{Fi} from each slave node 12, the master node 10 calculates the system-aggregate performance of each frequency band Fi in the channel, in particular the system-aggregate probability of error free transmission over the previous interval Pₜ (step 144),
Pₜ(Fi)=Σ(I_{Fi}/n) (2)
where n=the number of slave nodes.

Based on this, at step 146, the master node 10 identifies the worst-performing frequency bands by comparing their respective Pt over the last evaluation interval 120 and creates a black list of the two worst-performing frequencies.

At the end of the current epoch, i.e. after the configuration phase, the system again enters the evaluation phase 120. Now, armed with the knowledge of which frequencies are worst-performing the master nodes 10, 12 again follow the hop sequence F, but (i) the master node 10 omits to transmit on the two black-listed frequency bands because it knows that they are known to be poorly performing, and (ii) the master node 10 transmits a dummy packet in the frequency/time slot immediately preceding, time-wise, a frequency/time slot which is transmitted on a frequency band which has been black-listed. The dummy packet is addressed to a slave node piconet address for which there is no slave node currently assigned. By sending the dummy packet, the master node 10 is telling the other real, slave nodes 12 that the next U slot is reserved for the acknowledgment of the addressed (dummy) slave node 12, and in so doing, by indirect means, prevents transmission on the black-listed frequency band. In the case when the piconet is full and there are 7 slave nodes, the master node 12 pre-emptively puts one of the slave nodes into park mode to free up a dummy piconet slave address. In park mode, a slave node is merely maintaining synchronisation with the piconet and needs to be re-activated before it can again communication with the master node.

The system operation proceeds as before, except during the second and subsequent configuration phases 130, the parameters Pₜ(Fi) are adjusted according to the parameter α (where 0≦α≦1) is and the value of the Pₜ calculated during the previous configuration phase, P_{T-1}.
Pₜ(Fi)=α.Pₜ(Fi)+(1−α).Pₜ₋₁(Fi) (3)

This modification of Pₜ(Fi) has the effect, to an extent governed by the value of α, of making Pₜ reflect not only the frequency bands performance over the evaluation interval but also the historic performance over previous evaluation intervals.

If the situation is now considered where the system 5 is being used in the vicinity of a WLAN. This network sporadically transmits relatively long packets of information in an area of the spectrum which falls within the frequency bands used by the system 5. An example of the interference of this neighbouring WLAN is shown in FIG. 5 and denoted 102. It will be appreciated that for the portion of the hopping sequence F shown in FIG. 5, the F7 and F8 frequency bands are completely swamped by the long packet transmission of the WLAN. By comparison with FIG. 1, we can see that frequency/time slots 100e and 100g have been rendered useless. Although only a small portion of the hopping sequence is visible in FIG. 5 if we assume that transmissions of the WLAN have disrupted F7 and F8 for much of an evaluation interval, then it will be appreciated that any slave node 12 which tries to make use of F7, F8 is not likely to meet with much success. As a result, the slave nodes all calculate during the evaluation phase 120 local interference indices for I_{F7} and I_{F8}, according to equation (1) above, which are considerably smaller than for the indices of the other frequency bands F1-6. Accordingly, during the configuration phase 130, the master node 10 collects the local interference indices from each slave node 12 and calculates a system-aggregate probability of error-free transmission Pₜ for each frequency F1 to F8 according to equation (2) and adjusts it according to historic information as per equation (3), the master node identifies frequency bands F7 and F8 as the worst performing, i.e. most interfered with, frequency bands and so places them on a black list (step 146). At the start of the next evaluation phase 120, with this knowledge of which frequency bands have been black listed, the master node 10 refrains from transmitting on any frequency/time slots which fall in a black-listed frequency band. With reference to FIG. 1, it will be appreciated that there are no D slots which are transmitted on F7 or F8 in the example shown. However, there are two U slots 100e, transmitted on F7, and 100g transmitted on F8. In order to forestall transmission on these frequency/time slots, the master node 10 transmits to a dummy slave node, say a fifth slave node 12e, which is not shown in FIG. 1 because it does not exist. By virtue of this transmission, all the slave nodes 12a-d are not permitted to transmit on the immediately succeeding U slots, 100e and 100g. In this way, the system 5 aims to avoid in advance the RF hot spots in the local environment as shown in FIG. 6. This not only improves its own system performance, but also makes the system 5 far more sociable in RF terms to neighbouring systems e.g. a WLAN.

Once a frequency band has been black-listed it is no longer in use by the system and hence no fresh interference index is being calculated by the slave nodes. Therefore, the master node 10, when at step 146 it is deciding upon the black-listed channels for the next epoch, uses the value of the interference indices, which the currently black-listed channels had immediately before they were black listed scaled by β^{x} where β<1 and x is the number of epochs that the frequency band has been on the black list, as the basis of comparison with the newly-gathered interference indices from the unblack-listed frequency bands.

It will be appreciated that the selection of the system parameters α and β have a great influence on under what circumstances and for how long a given frequency band is black listed. For example, the greater the value of α, the greater the weighting given to the environment in only the previous evaluation phase 120. Whereas, if α has a small value, then greater weighting is given to the conditions in the environment in the past. Regarding β, if β is small, then the black-listed channels have a greater chance of being quickly taken off the black list as compared with when β is close to 1.

It will be appreciated that for ease of description and for concision a simplified embodiment has been described. For example, the number of frequency bands in the channel was 8. But in a practical system there are likely to be many more frequency bands. According to the FCC regulations, a frequency hopping system in accordance with this invention operating in the ISM band must hop onto 75 out of the possible 79 frequency bands available. Although in the described embodiment, two frequencies bands are placed onto the black list. In practice, this number may be dictated or at least constrained by governmental regulations.

In the described embodiment of the invention, the master node 10 collates the interference indices I_{Fi} by interrogating the slave nodes 12 in turn. In another embodiment, the slave nodes could sent this information after a predetermined time. In this case of course, the timing for the slave nodes to dispatch this information to the master node needs to be such that all the slave nodes access to the same U slot, to prevent excessive collisions between the slave nodes.

In the described embodiment of the invention, the evaluation period for each frequency band, but in other embodiments, the evaluation period for each node can be different, even substantially different.

1. A method of operating a frequency hopping spread spectrum comprising a central node and dependent nodes which communicate over a time division duplexed, frequency hopping channel, alternate time-wise frequency/time slots being allocated for central node and dependent node transmission, wherein a first of said dependent nodes is not permitted to transmit in a frequency/time slot which immediately succeeds, time-wise, a frequency/time slot in which the central node transmitted to another of said dependent nodes, comprising the steps of:
the central node maintaining a black-list of worse-performing frequency bands in the channel, and transmitting a dummy packet in a frequency/time slot immediately preceding, time-wise, a frequency/time slot allocated for possible dependent node transmission at a frequency band which is black-listed.

2. A method as in claim 1, wherein the central node refrains from transmitting on a black-listed frequency/time slot.

3. A Bluetooth node comprising means for maintaining a black-list of worse performing frequency bands, and means for transmitting a dummy packet in a frequency/time slot immediately preceding, time-wise, a frequency/time slot allocated for possible slave node transmission at a frequency band which is black-listed.

4. A Bluetooth node as in claim 3, comprising means for refraining from transmitting on a given frequency/time slot on the basis of the black-list.
